(19) United States
(12) Patent Application Publication
(10) Pub. No.: US 2008/0061106 A1
(43) Pub. Date: Mar. 13, 2008

(54) Stapler having a force balance effect

(76) Inventor: Chun-Yuan Chang, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/518,031

(22) Filed: Sep. 11, 2006

(51) Int. Cl. B25C 5/06

(52) U.S. Cl. 227/132

(57) ABSTRACT

A stapler includes a main body, a striking plate, a trigger plate, an elastic plate, a top cover, a restoring spring, a base, and a safety device. Thus, the positioning portions of the elastic plate have the same size and the same bent angle to provide a force which is distributed on the striking plate evenly to drive the striking plate to perform the stapling action exactly and smoothly, thereby enhancing the stapling efficiency of the stapler. In addition, when the base is detached from the main body, the top cover is locked by the positioning block to prevent the top cover from being pressed unintentionally so that the striking plate will not be triggered by pressing the top cover so as to protect the user's safety.

### BACKGROUND OF THE INVENTION

1. Field of the Invention

The present invention relates to a stapler and, more particularly, to a stapler that is operated like a nailing machine.

2. Description of the Related Art

A conventional stapler in accordance with the prior art shown in FIGS. 9 and 10 comprises a main body 17, a striking plate 14 movably mounted on a front side of the main body 17 and having a locking hole 15 and two positioning holes 16 and 16′, a bent trigger plate 10 pivotally mounted on the main body 17 and having a front end formed with a plug 11 detachably mounted in the locking hole 15 of the striking plate 14, two springs 12 and 13 located at two sides of the trigger plate 10 and each having a front end mounted in the positioning holes 16 and 16′ of the striking plate 14, a top cover 21 pivotally mounted on the main body 17 and having a press block 22 that is movable to rest on a second end of the trigger plate 10, and a restoring spring mounted on a mediate portion of the trigger plate 10 and biased between the main body 17 and the trigger plate 10.

In operation, when the top cover 21 is pressed to move toward the main body 17, the second end of the trigger plate 10 is pressed downward by the press block 22 of the top cover 21 to drive and pivot the trigger plate 10 so that the plug 11 of the trigger plate 10 is moved upward to lift the striking plate 14 which lifts the front ends of the two springs 12 and 13 simultaneously to produce a restoring force. After the second end of the trigger plate 10 is moved upward to a determined position, the second end of the trigger plate 10 is detached from the locking hole 15 of the striking plate 14 to release the striking plate 14, so that the striking plate 14 is driven by the restoring force of the two springs 12 and 13 to move downward so as to accomplish the stapling action in a striking manner. Thus, the stapler is operated like a nailing machine by action of the striking plate 14.

However, the two springs 12 and 13 are manufactured individually, so that the two springs 12 and 13 have tolerance during the working process to produce different elastic forces which are not distributed on the striking plate 14 evenly, thereby affecting the stapling action of the striking plate, and thereby decreasing the stapling efficiency of the stapler. In addition, the striking plate 14 is triggered by pressing the top cover 21, so that the striking plate 14 is easily ejected when the top cover 21 is pressed unintentionally, thereby causing danger to a user.

The closest prior art references of which the applicant is aware were disclosed in U.S. Pat. Nos. 6,918,525 and 7,014,090.

### BRIEF SUMMARY OF THE INVENTION

In accordance with one embodiment of the present invention, there is provided a stapler, comprising a main body, an upright striking plate movably mounted on a front side of the main body and having a locking hole and two positioning holes, an elongated straight trigger plate pivotally mounted on the main body and having a front end formed with a protruding plug detachably mounted in the locking hole of the striking plate and a rear end formed with a sideward extending protruding block and a recess, an elastic plate mounted on the main body and having a forked front end formed with two angled bent positioning portions mounted in the positioning holes of the striking plate and an elongated slot defined between the positioning portions, a top cover pivotally mounted on the main body and having a mediate portion having an inner side provided with a press block rested on the protruding block of the trigger plate, a restoring spring mounted on the trigger plate and biased between the top cover and the main body, and a base pivotally mounted on the main body so that the main body is located between the top cover and the base.

In accordance with another embodiment of the present invention, there is provided a stapler, comprising a main body, a top cover pivotally mounted on the main body and having a bottom formed with two reinforcing ribs and an elongated channel located between the two reinforcing ribs, a base pivotally mounted on the main body so that the main body is located between the top cover and the base, and a safety device mounted between a rear side of the main body and the top cover and including a positioning block movably mounted on the main body and located under the top cover and having a first side formed with a mounting hole and a second side formed with a reduced ramp protruding outwardly from the main body and rested on a side wall of the base, and a spring mounted in the mounting hole of the positioning block and biased between a side wall of the main body and the positioning block to push the positioning block.

The primary objective of the present invention is to provide a stapler having a force balance effect.

Another objective of the present invention is to provide a stapler, wherein the force applied from the press block of the top cover through the trigger plate to the striking plate is transmitted in a linear path to provide a force balance effect to drive the striking plate to move toward the base optimally and exactly.

A further objective of the present invention is to provide a stapler, wherein the positioning portions of the elastic plate have the same size and the same bent angle so that the positioning portions of the elastic plate provide a force which is distributed on the striking plate evenly to provide a force balance effect to drive the striking plate to perform the stapling action exactly and smoothly, thereby enhancing the stapling efficiency of the stapler.

A further objective of the present invention is to provide a stapler, wherein when the base is detached from the main body, the top cover is locked by the positioning block to stop operation of the stapler to prevent the top cover from being pressed unintentionally so that the striking plate will not be triggered by pressing the top cover so as to protect the user's safety.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a stapler in accordance with the preferred embodiment of the present invention.

FIG. 2 is a broken perspective view of the stapler as shown in FIG. 1.

FIG. 3 is a perspective view of a trigger plate of the stapler as shown in FIG. 2.

FIG. 4 is a perspective view of an elastic plate of the stapler as shown in FIG. 2.

FIG. 5 is a perspective view of a positioning block of the stapler as shown in FIG. 2.

FIG. 6 is a locally enlarged perspective view of the stapler as shown in FIG. 2.

FIG. 7 is a schematic operational view of the stapler as shown in FIG. 6.

FIG. 8 is a schematic operational view of the stapler as shown in FIG. 1.

FIG. 9 is a perspective view of a conventional stapler in accordance with the prior art.

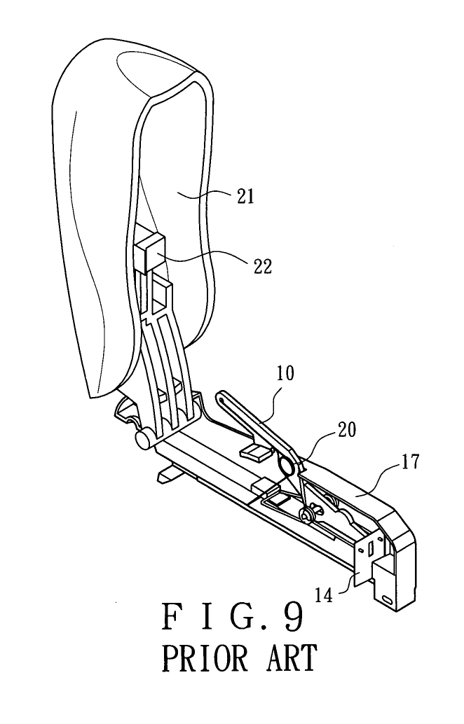

FIG. 10 is a locally enlarged perspective view of the conventional stapler as shown in FIG. 9.

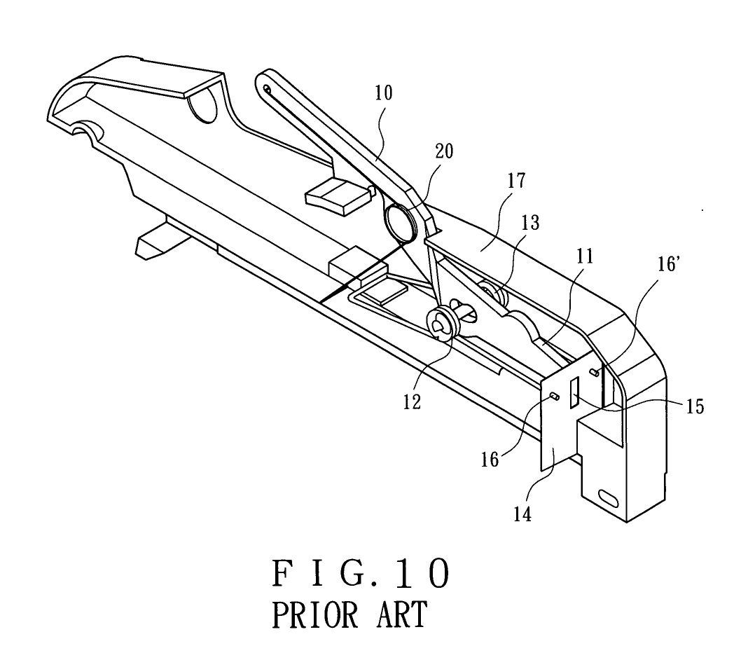

### DETAILED DESCRIPTION OF THE INVENTION

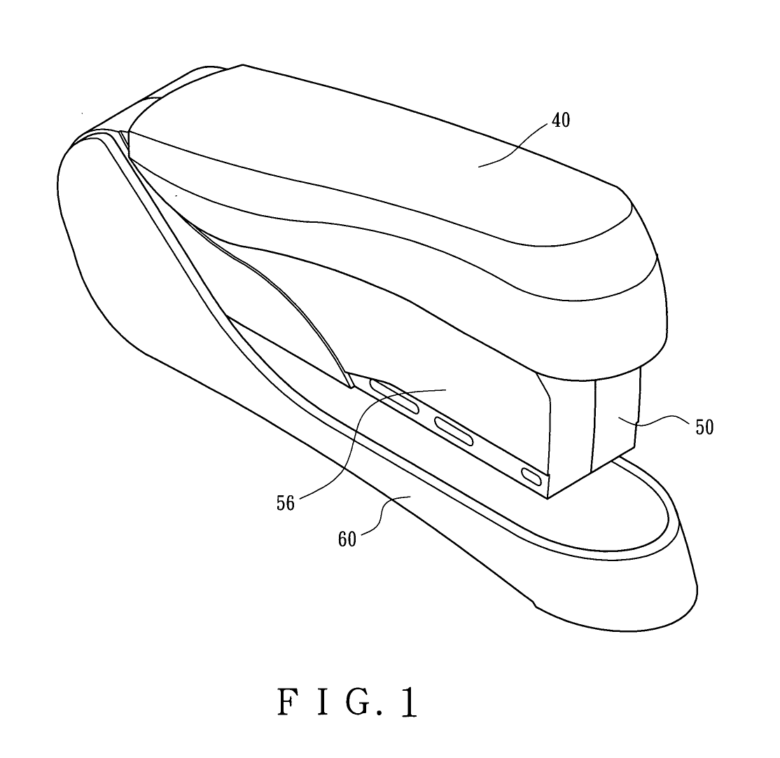

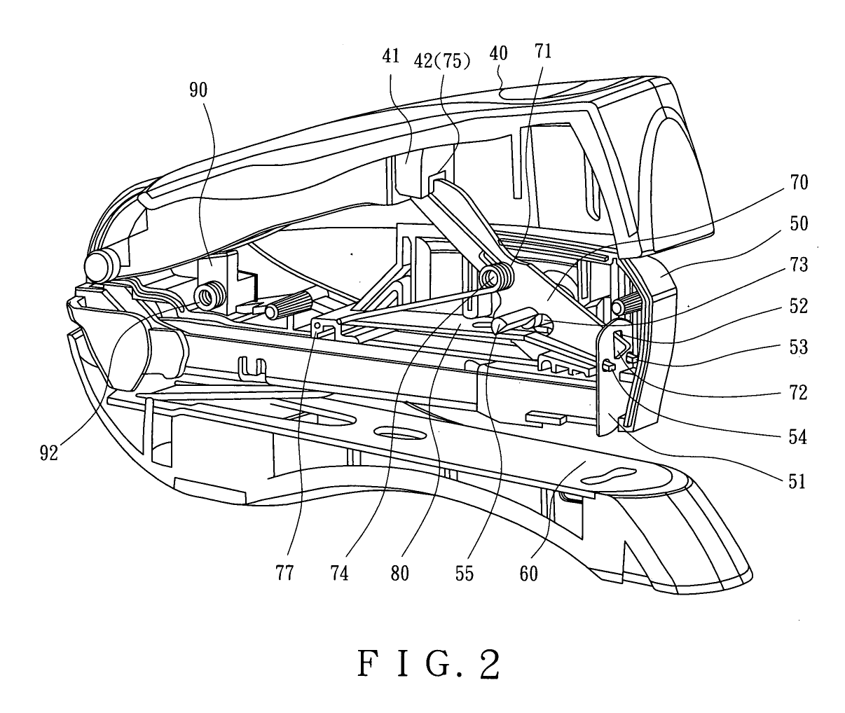

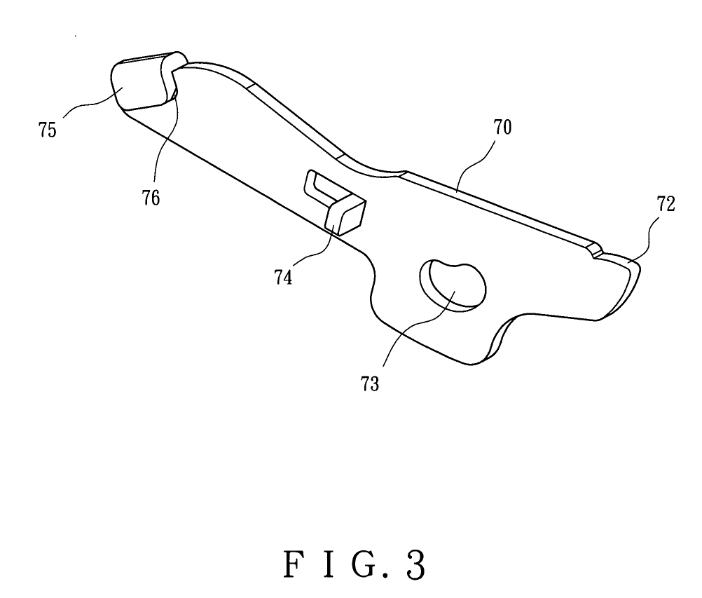

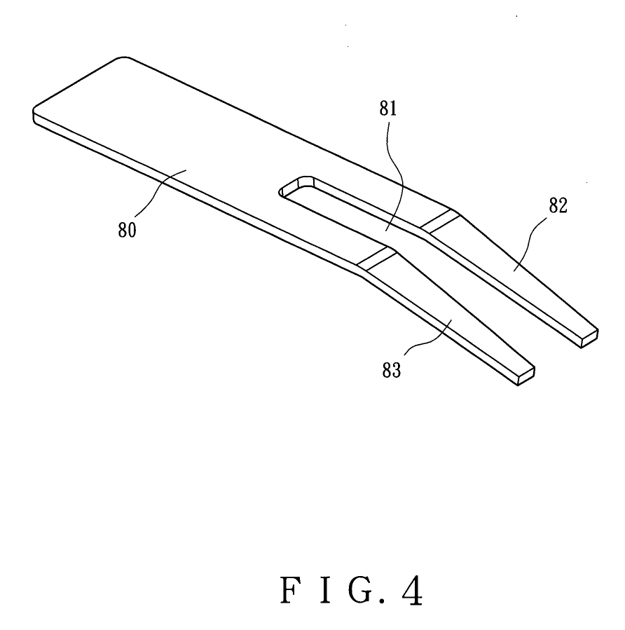

Referring to the drawings and initially to FIGS. 1-4, a stapler in accordance with the preferred embodiment of the present invention comprises a main body 50, an upright striking plate 51 movably mounted on a front side of the main body 50 and having a locking hole 52 and two positioning holes 53 and 54, an elongated straight trigger plate 70 pivotally mounted on the main body 50 and having a front end formed with a protruding plug 72 detachably mounted in the locking hole 52 of the striking plate 51 and a rear end formed with a sideward extending protruding block 75 and a recess 76, an elastic plate 80 mounted on the main body 50 and having a forked front end formed with two angled bent positioning portions 82 and 83 mounted in the positioning holes 53 and 54 of the striking plate 51 and an elongated slot 81 defined between the positioning portions 82 and 83, a top cover 40 having a rear end pivotally mounted on the main body 50 and a mediate portion having an inner side provided with a press block 41 rested on the protruding block 75 of the trigger plate 70, a restoring spring 71 mounted on the trigger plate 70 and biased between the top cover 40 and the main body 50, and a base 60 having a rear end pivotally mounted on the main body 50 so that the main body 50 is located between the top cover 40 and the base 60.

The press block 41 of the top cover 40 is located at an inner side of the top cover 40 and has a bottom formed with a recessed surface 42 enclosed around the protruding block 75 of the trigger plate 70 completely. The press block 41 of the top cover 40, the trigger plate 70 and the striking plate 51 are combined in a linear manner.

The elastic plate 80 is located under the trigger plate 70. The elongated slot 81 of the elastic plate 80 is located at a central portion between the positioning portions 82 and 83, and the positioning portions 82 and 83 of the elastic plate 80 have the same size and the same bent angle.

The front end of the trigger plate 70 has a mediate portion formed with an oblong slot 73 to allow passage of a pivot shaft 55 which is mounted in the main body 50 to function as a pivot fulcrum of the trigger plate 70. The trigger plate 70 has a mediate portion formed with a protruding mounting portion 74 for mounting the restoring spring 71. The recess 76 of the trigger plate 70 is formed in a front edge of the protruding block 75. A positioning seat 77 is mounted in the main body 50 to position the restoring spring 71 and the elastic plate 80.

In operation, when the top cover 40 is pressed to move toward the main body 50, the protruding block 75 of the trigger plate 70 is pressed downward by the press block 41 of the top cover 40 to drive the trigger plate 70 to pivot about the pivot shaft 55 so that the protruding plug 72 of the trigger plate 70 is moved upward to lift the striking plate 51 which lifts the positioning portions 82 and 83 of the elastic plate 80 simultaneously to produce a restoring force.

After the protruding plug 72 of the trigger plate 70 is moved upward to a determined position, the protruding plug 72 of the trigger plate 70 is detached from the locking hole 52 of the striking plate 51 to release the striking plate 51, so that the striking plate 51 is driven by the restoring force of the positioning portions 82 and 83 of the elastic plate 80 to move downward toward the base 60 quickly and violently so as to accomplish the stapling action in a striking manner. Thus, the stapler is operated like a nailing machine by action of the striking plate 51.

Accordingly, the force applied from the press block 41 of the top cover 40 through the trigger plate 70 to the striking plate 51 is transmitted in a linear path to provide a force balance effect to drive the striking plate 51 to move toward the base 60 optimally and exactly. In addition, the positioning portions 82 and 83 of the elastic plate 80 have the same size and the same bent angle so that the positioning portions 82 and 83 of the elastic plate 80 provide a force which is distributed on the striking plate 51 evenly to provide a force balance effect to drive the striking plate 51 to perform the stapling action exactly and smoothly, thereby enhancing the stapling efficiency of the stapler.

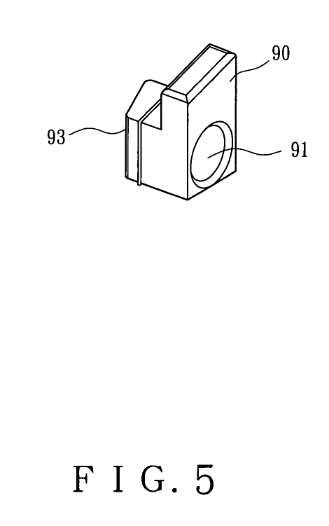

Referring to FIGS. 5-8 with reference to FIGS. 1-4, the stapler further comprises a safety device mounted between a rear side of the main body 50 and the top cover 40. The top cover 40 has a bottom formed with two reinforcing ribs 44 and an elongated channel 43 located between the two reinforcing ribs 44. The safety device includes a substantially L-shaped positioning block 90 movably mounted on the main body 50 and located under the top cover 40 and having a first side formed with a mounting hole 91 and a second side formed with a reduced ramp 93 protruding outwardly from the main body 50 and rested on a side wall 62 of the base 60, and a spring 92 mounted in the mounting hole 91 of the positioning block 90 and biased between a side wall 56 of the main body 50 and the positioning block 90 to push the positioning block 90 so that when the ramp 93 of the positioning block 90 is rested on the side wall 62 of the base 60, the spring 92 is compressed and the positioning block 90 is aligned with the elongated channel 43 of the top cover 40 to allow the top cover 40 moving toward the main body 50, and when the ramp 93 of the positioning block 90 is detached from the side wall 62 of the base 60, the positioning block 90 is pushed by a restoring force of the spring 92 to align with one of the two reinforcing ribs 44 of the top cover 40 to stop movement of the top cover 40 to prevent the top cover 40 from being moved toward the main body 50.

Thus, when the base 60 is folded onto the main body 50, the ramp 93 of the positioning block 90 is pressed by the side wall 62 of the base 60 and retracted into the main body 50, and when the base 60 is detached from the main body 50, the ramp 93 of the positioning block 90 is detached from the side wall 62 of the base 60 and protruded outwardly from the main body 50.

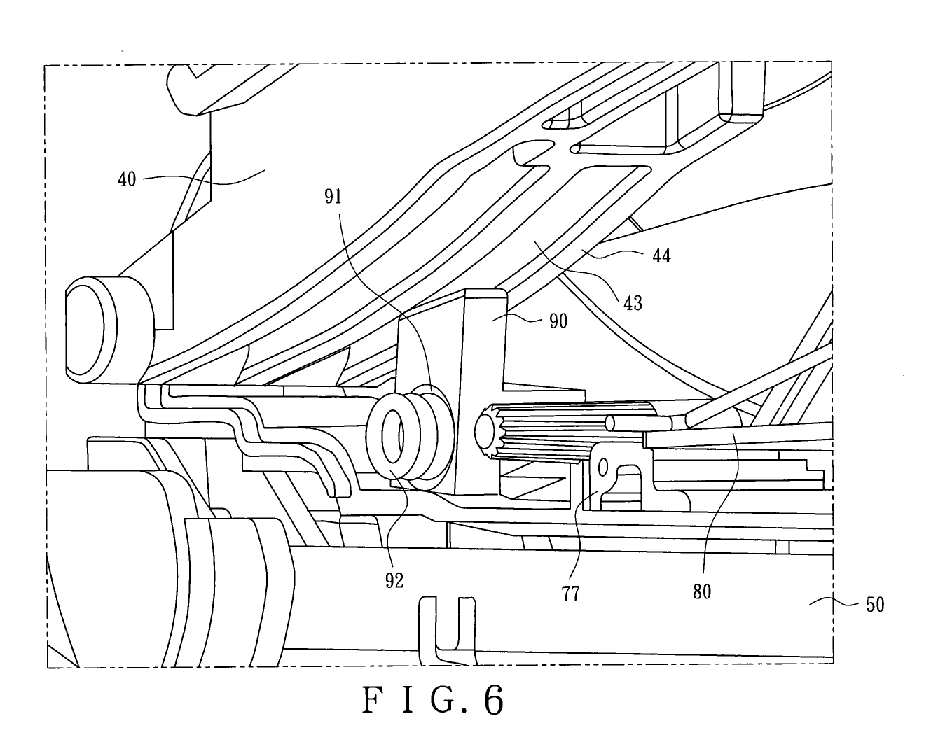

In operation, when the ramp 93 of the positioning block 90 is pressed by the side wall 62 of the base 60, the spring 92 is compressed and the positioning block 90 is aligned with the elongated channel 43 of the top cover 40 as shown in FIG. 6 to allow the top cover 40 moving toward the main body 50, so that the top cover 40 is movable toward the main body 50 to accomplish the stapling action.

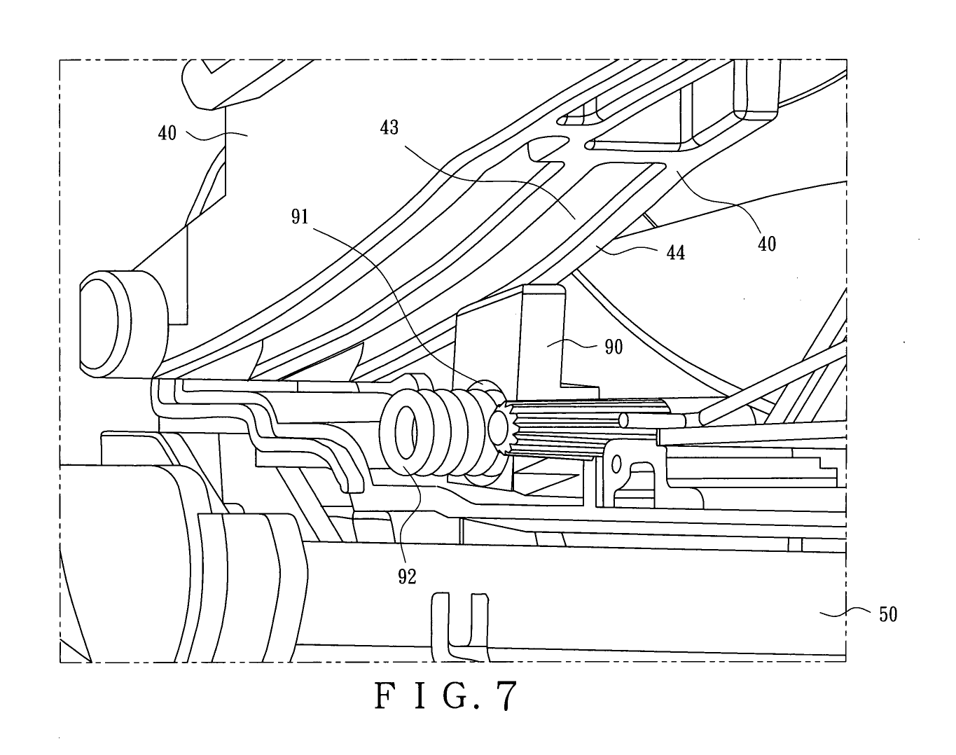

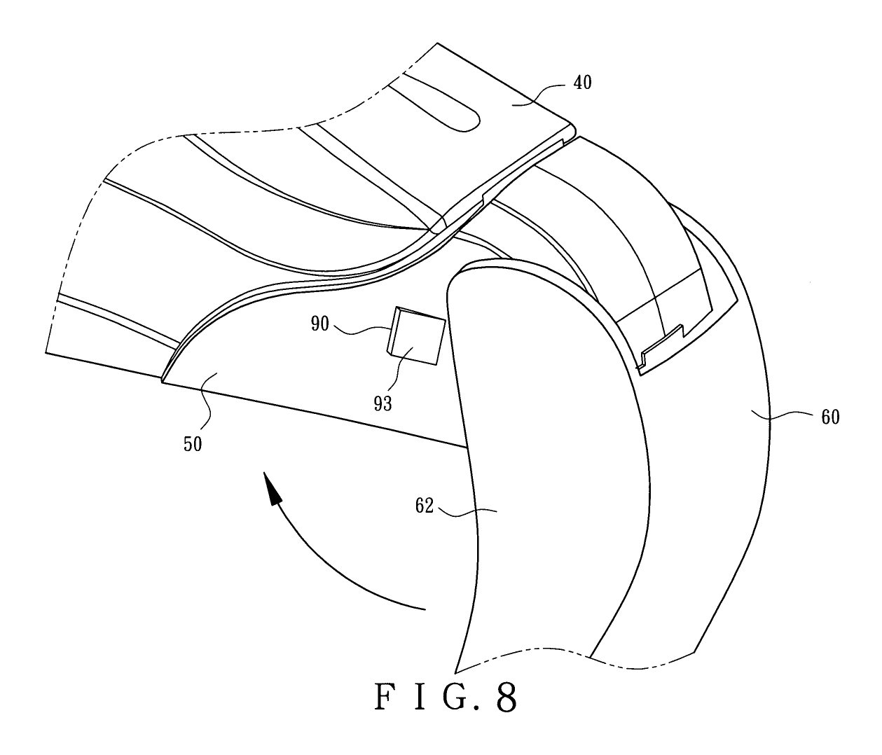

On the contrary, when the ramp 93 of the positioning block 90 is detached from the side wall 62 of the base 60 after the base 60 is detached from the main body 50 as shown in FIG. 8, the positioning block 90 is pushed by the restoring force of the spring 92 to align with one of the two reinforcing ribs 44 of the top cover 40 as shown in FIG. 7 to stop movement of the top cover 40 to prevent the top cover 40 from being moved toward the main body 50 so as to stop operation of the stapler. At this time, the ramp 93 of the positioning block 90 is detached from the side wall 62 of the base 60 and protruded outwardly from the main body 50 as shown in FIG. 8.

Accordingly, when the base 60 is detached from the main body 50, the top cover 40 is locked by the positioning block 90 to stop operation of the stapler to prevent the top cover 40 from being pressed unintentionally so that the striking plate 51 will not be triggered by pressing the top cover 40 so as to protect the user's safety.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A stapler, comprising:
a main body;
an upright striking plate movably mounted on a front side of the main body and having a locking hole and two positioning holes;
an elongated straight trigger plate pivotally mounted on the main body and having a front end formed with a protruding plug detachably mounted in the locking hole of the striking plate and a rear end formed with a sideward extending protruding block and a recess;
an elastic plate mounted on the main body and having a forked front end formed with two angled bent positioning portions mounted in the positioning holes of the striking plate and an elongated slot defined between the positioning portions;
a top cover pivotally mounted on the main body and having a mediate portion having an inner side provided with a press block rested on the protruding block of the trigger plate;
a restoring spring mounted on the trigger plate and biased between the top cover and the main body;
a base pivotally mounted on the main body so that the main body is located between the top cover and the base.

2. The stapler in accordance with claim 1, wherein the press block of the top cover is located at an inner side of the top cover and has a bottom formed with a recessed surface enclosed around the protruding block of the trigger plate completely.

3. The stapler in accordance with claim 1, wherein the press block of the top cover, the trigger plate and the striking plate are combined in a linear manner.

4. The stapler in accordance with claim 1, wherein the positioning portions of the elastic plate have the same size and the same bent angle.

5. A stapler, comprising:
a main body;
a top cover pivotally mounted on the main body and having a bottom formed with two reinforcing ribs and an elongated channel located between the two reinforcing ribs;
a base pivotally mounted on the main body so that the main body is located between the top cover and the base;
a safety device mounted between a rear side of the main body and the top cover and including a substantially L-shaped positioning block movably mounted on the main body and located under the top cover and having a first side formed with a mounting hole and a second side formed with a reduced ramp protruding outwardly from the main body and rested on a side wall of the base, and a spring mounted in the mounting hole of the positioning block and biased between a side wall of the main body and the positioning block to push the positioning block.

6. The stapler in accordance with claim 5, wherein when the ramp of the positioning block is rested on the side wall of the base, the spring is compressed and the positioning block is aligned with the elongated channel of the top cover to allow the top cover moving toward the main body, and when the ramp of the positioning block is detached from the side wall of the base, the positioning block is pushed by a restoring force of the spring to align with one of the two reinforcing ribs of the top cover to stop movement of the top cover to prevent the top cover from being moved toward the main body.

7. The stapler in accordance with claim 6, wherein when the base is folded onto the main body, the ramp of the positioning block is pressed by the side wall of the base and retracted into the main body.

8. The stapler in accordance with claim 6, wherein when the base is detached from the main body, the ramp of the positioning block is detached from the side wall of the base and protruded outwardly from the main body.
